(19) United States
(12) Patent Application Publication
(10) Pub. No.: US 2024/0176631 A1
(43) Pub. Date: May 30, 2024

(54) WIZARD BASED GATEWAY ONBOARDING TO CLOUD

(71) Applicant: HONEYWELL INTERNATIONAL INC., Charlotte, NC (US)

(72) Inventors: Vijay RAJU, Charlotte, NC (US); Venugopala NADUMANE, Charlotte, NC (US); Rajiv SINGH, Charlotte, NC (US); Marco NOSTRINI, Charlotte, NC (US); Vaibhav AGARWAL, Charlotte, NC (US); Prabhat RANJAN, Charlotte, NC (US); Narayanaswamy BANDI, Charlotte, NC (US)

(21) Appl. No.: 18/519,891

(22) Filed: Nov. 27, 2023

(30) Foreign Application Priority Data
Nov. 29, 2022 (IN) 202211068696

(51) Int. Cl. G06F 9/451; H04L 41/0806

(52) U.S. Cl. CPC G06F 9/453; H04L 41/0806

(57) ABSTRACT

An onboarding wizard that may automatically scan the network for devices, points, history, alarms, and schedules. Automatically, things will get added based on metadata information exposed over the network driver. Users may review the items discovered by an automated process and then remove them if any items are not needed. The wizard may register the cloud connector to cloud IoT for pushing the data. The wizard may also apply tagging for the points and equipment, automatically, based on the tag dictionary. The system may consist of a minimum tagging and asset model creation in the gateway as part of gateway onboarding. This model may be published to a cloud supervisor and get stored in a model store. Once the model is available in the cloud, an asset modelling feature allows a user, with privileges, to enhance the model by adding extra context about points and equipment.

### CROSS-REFERENCE TO RELATED APPLICATIONS

This application claims priority pursuant to 35 U.S.C. 119(a) to Indian Application No. 202211068696, filed Nov. 29, 2022, which application is incorporated herein by reference in its entirety.

### BACKGROUND

The present system and approach relate to integrated building management systems such as heating, ventilating, and air-conditioning (HVAC), lighting systems, VRF, and electric and mechanical types of equipment.

### SUMMARY

The present disclosure may relate to an onboarding wizard, that may automatically scan the network for devices, points, history, alarms, and schedules. Automatically, everything may get added based on metadata information exposed over the BACnet driver. Users can review the items discovered by an automated process and remove them if any items are not necessarily needed. Wizard may register the cloud connector to cloud IoT for pushing the data. Wizard may also apply tagging for the points and equipment, automatically based on the tag dictionary. By default, a tag dictionary may have all equipment and tags available for HVAC applications. If users need any customization, they may do it once and it take changes for all other jobs. Users may review the tags automatically applied and adjust them needed. If everything is fine, then one may go ahead and perform a sync of the asset model generated in the gateway to the cloud.

The system may consist of a creation of bare minimum tagging and asset model creation in the gateway as part of gateway onboarding. This model may get published to a cloud supervisor and get stored in a model store. Once the model is available in the cloud, asset modelling feature may allow a user, with privileges, to enhance the model by adding extra context about points and equipment based on name and description of points, devices, and so forth. The term “context” may have a several meanings in the present specification, depending upon its usage and topic of application. It may refer to content of the subject matter or term at hand or context (i.e., background, setting, situation and/or so on) of the subject matter or term

Asset modelling may automatically suggest an enhancement to tagging and the asset model based on available context. Users may be allowed to review and adjust accordingly. Once reviewed, users can publish the changes back to the model. Users may review the changes in the supervisor virtually instantly and make sure that everything is done correctly. Any changes needed to be applied in the gateway may be sent as a system command to the gateway. Automatically, the gateway may adjust the entities for the asset modelling performed in the cloud.

### BRIEF DESCRIPTION OF THE DRAWINGS

FIG. 1 is a diagram revealing an internet configuration;

FIG. 2 is a diagram revealing a BACnet network configuration;

FIG. 3 is a diagram revealing a BACnet device configuration;

FIG. 4 is a diagram revealing a cloud configuration;

FIG. 5 is a diagram revealing a review and cloud sync;

FIG. 6 is a diagram of an onboarding architecture;

FIG. 7 is a diagram of a gateway onboarding user navigation;

FIG. 8 is a diagram of a basic layout of a system for the present onboarding;

FIG. 9 is a diagram of an example screen or dashboard showing selections for asset modeling (if selected) or for ADR settings or gateway configuration;

FIG. 10 is a diagram of an example of assigned existing equipment;

FIG. 11 is a diagram of an example of assigned new equipment;

FIG. 12 is a diagram for an add point role.

FIG. 13 is a diagram of an example architecture of the present system and approach;

FIG. 14 is a diagram of a generation of a building ontology model;

FIG. 15 is a diagram showing a generation of a building ontology model;

FIG. 16 is a diagram of a model creating a sync workflow chart;

FIG. 17 is a diagram showing a point tagging application programming interface (API) design;

FIG. 18 is a diagram representing a point tagging API workflow; and

FIG. 19 is a diagram of a system architecture.

### DESCRIPTION

The present system and approach relate to integrated building management systems such as heating, ventilating, and air-conditioning (HVAC), lighting systems, VRF, and electric and mechanical types of equipment. In today's world, many of the HVAC and building management system (BMS) projects, jobs would be spread across multiple geographical locations. In BMS projects, each job site may consist of BMS Supervisor which can be connected to the plant controller and unitary controllers to control different kinds of equipment in HVAC system. Meanings of acronyms may be inferred herein by their context and/or art of usage.

The system may relate to an onboarding wizard, that can automatically scan the network for devices, points, history, alarms, and schedules. Automatically everything may get added based on metadata information exposed over the BACnet driver. Users may review the items discovered by an automated process and remove them if any items are not necessarily needed. Wizard may register the cloud connector to cloud IoT for pushing the data. Wizard may also apply tagging for the points and equipment, automatically based on the tag dictionary. By default, a tag dictionary may have all equipment and tags available for HVAC applications. If users need any customization, they may do it once and it can take those changes for all other jobs. Users may review the tags automatically applied and adjust them needed. If everything is fine, then it may go ahead and perform a sync of the asset model generated in the gateway to the cloud.

The system may consist of a creation of bare minimum tagging and asset model creation in the gateway as part of gateway onboarding. This model may be published to a cloud supervisor and get stored in a model store. Once the model is available in the cloud, an asset modelling feature may allow a user, with privileges, to enhance the model by adding extra context about points and equipment based on name and description of points, devices, and so forth. Asset modelling may automatically suggest an enhancement to tagging and the asset model based on available context. Users will be allowed to review and adjust accordingly. Once reviewed, users may publish the changes back to the model. Users may review the changes in the supervisor virtually instantly and make sure that everything is done correctly. Any changes needed to be applied in the gateway may be sent as a system command to the gateway. Automatically, the gateway may adjust the entities for the asset modelling performed in the cloud.

The building management system may provide access and control to every area and process of your building infrastructure. Three types of BMS supervisor deployment landscape may exist based on the size and footprint of the site. This may include single site, multi-site, and cloud-based deployment models.

Following are issues that may exist in current BMS onboarding for getting a cloud supervisor setup. Users may need to manually setup the different drivers in the gateway. For e.g., in Niagara JACE, users should add and setup BACnet, Modbus, Fox driver, and/or so on.

A Fox driver may manually discover devices and add points, history, schedules, and alarms. During point adding, users may need to choose the point type and make it writable. This current manual onboarding steps for a site having 1500 points may take up to two to three days of work for a system integrator. Currently, onboarding steps should be done on the end customer site which adds extra money. There appears no consistent user experience across products from onboarding to getting the cloud supervisor running.

The system may be used across BMS projects such as a remote building manager, SaMBa supervisor, common supervisor, and so on. The system may solve simplified and intuitive methods for onboarding a gateway to a cloud supervisor. The gateway onboarding wizard may be optimized for a BACnet protocol. Gateway onboarding may also be performed by a non-Niagara expert.

There may be an onboarding wizard with automated onboarding of HVAC controllers to a cloud. It may discover and add items such as points, alarms, history, and schedules from controllers without any user intervention. There may be automated tagging of points and equipment, an intuitive and easy process for onboarding, and a reduction in onboarding time for a site.

How to make and use the present system and process may be noted. There may be a station running the JACE gateway. This may be a default station that has a service and UX wizard available for assisting the onboarding. The onboarding wizard may run through a series of steps. A first step is to select an environment subject to a General Data Protection Regulation or not subject to such an area. A second step may be a network configuration that will automatically verify internet connectivity once configured. Upon verifying Internet connectivity, a user may be prompted to continue with the wizard (BACnet protocol) or a Niagara expert mode (Workbench view for Modbus, Fox Protocol). Continuing with the Wizard, a third step is to configure a BACnet network. Once configured, the BACnet network may automatically scan the network for devices, points, history, alarms, and schedules. Automatically, everything may get added based on metadata information exposed over the BACnet driver. This may help in setting all configurations without a need for manual intervention thereby reducing the onboarding time. Users may review the items discovered by an automated process and remove them if any items are not needed. Once removed and marked, next time, it will not necessarily include the items.

A fourth step may be that the wizard registers the cloud connector to a cloud IoT for pushing data. The wizard may also apply tagging for the points and equipment automatically based on a tag dictionary. By default, the tag dictionary may have all equipment and tags available for HVAC applications. If users need any customization, they may do the customization once and take those changes of the customization for all other jobs.

A fifth step may be where users can review the tags automatically applied and adjust them if needed. If everything of a review is acceptable, then the wizard may go ahead and perform a sync of an asset model generated in the gateway to the cloud. The present system may be used across BMS projects such as remote building manager, SaMBa, Supervisor, Common Supervisor, and so forth.

The present system does have a software component. It may be a stack level: gateway/control for control, management, administration, operations and data consolidation applications, or a translation layer between a local environment and cloud enabling communication.

The system may have a software type connected/connectivity as an offering available through a cloud or a direct, remote connection (SaaS) or it may cover infrastructure enabling connected services (Sentience). It may use an IoT that is a stack level of a cloud having a secure, scalable infrastructure for collecting, aggregating and storing data, allowing connected “things” to communicate, offering/SaaS solution available, IaaS/PaaS, and data lakes.

The system may generate or capture data having a type of model based auto tagging point sync-up with a cloud. For instance, the data may be that of a HVAC sensor.

Systems and methods for remote asset modelling and tuning for a cloud supervisor may be noted. Critical subsystems of a building may include heating, ventilation and air-conditioning (HVAC) control, lighting control, systems energy management load shedding, UPS, elevator and escalator control systems, miscellaneous building systems including pumps, sumps, and so forth.

A BMS supervisor may save you money on operating costs while protecting your property, buildings and assets. The BMS supervisor may provide access and control of every area and process of your building infrastructure. Many of the BMS supervisors may have intuitive, easy to understand, easy to use, and effective graphics pages which make it easy for building maintenance staff to operate and maintain the site. Mainly end customers may interact with the BMS supervisor using points, history/trends, alarms and schedules.

There may be three types of BMS supervisor deployment landscapes that exist, based on the size and footprint of the site. They may include single site, multi-site and cloud based deployment models. In a single site, standalone deployment, a BMS supervisor may be installed on a premise in a customer location either as an embedded supervisor or installed on a PC, which will relate to controllers and field devices. In a large site, multi-site deployment may be a scalable solution for a data center and other big jobs in which data are maintained on a premise in a customer hosted or service provider hosted data center. In a cloud based deployment, a complete supervisor may be hosted in a cloud which will be connected to on premise systems in customer locations.

Following are the issues that may exist in the current BMS gateway onboarding for getting a cloud supervisor setup. Tagging may be used in a cloud supervisor for getting context about an asset model. During gateway onboarding, based on points and devices, points and equipment may get tagged. Based on these tags, the asset model may get created in a gateway and get pushed to a supervisor in the cloud.

Users should review the model and tags in the supervisor and adjust the tags in the gateway again and resync, once the changes done. Many times, this system tagging may take multiple rounds to and from changes which can take days. Users should be on site for performing these model changes. If any changes are needed or desired later, users should travel back to the site. Automated tagging, based on context of point names, description name, device name, description and so forth, may be only available in the gateway and not necessarily be possible to adapt in a cloud.

The present system may be used across BMS projects such as remote building manager, SaMBa supervisor, common supervisor, CEMS, and so forth. There may be automated tagging of points and equipment in the cloud. One may get context automatically from related entities such as a point and device name, description, and so on. The asset model may be easily enhanced by applying templates for a site which does not have any naming convention. There may be automatic adjustments of entities and relationships in the gateway when the asset model changes are done in a cloud. A process for adjusting the asset modelling from cloud may be intuitive and easy. Onboarding time for a site may be reduced.

A solution may consist of a bare minimum tagging and asset model creation in the gateway as part of gateway onboarding. This model may get published to a cloud supervisor and get stored in the model store. Once the model is available in the cloud, an asset modelling feature may allow a user, with privileges, to enhance the model by adding extra context about points and equipment based on name and description of points, devices, and so on.

Asset modelling may automatically suggest enhancement to tagging and an asset model based on available context. Users may be allowed to review and adjust accordingly. Once reviewed, users can publish the changes back to the model. Users may review the changes in a supervisor instantly and make sure that everything is done correctly. Any changes needed to be applied in the gateway may be sent as a system command to the gateway. Automatically, the gateway may adjust the entities for the asset modelling performed in the cloud. This approach may reduce the time needed in the site and it should be possible to load a site having up to 5,000 points within one hour compared to earlier multiple days of work needed for the same number of points.

The present system may be used across BMS projects such as remote building manager, SaMBa, supervisor, common supervisor, and so on.

All BMS controllers and south bound devices will be connected through a gateway to a Forge™ IOT and then to a cloud supervisor. In the cloud supervisor, there may be a service which will read data from a history and the gateway to show a single dashboard of virtually all points and related information. System architecture and design details may be noted.

A simple generic model in gateway may be built in following format.

{
“addedObjects”: [
{
“entityType”: “SpatialElement”,
“values”: [{
“containsSpatialElements”: [ ],
“createdAt”: “2021-05-03T11:49:57.859+05:30”,
“createdBy”: “00000000-0000-0000-0000-000000000000”,
“customAttributes”: { },
“description”: null,
“id”: “d467f98c-1512-4e61-b804-47ba753e3cc7”,
“name”: “HTS_BLR_BTS”,
“parentSpatialElementId”: null,
“siteId”: “57ba1fbc-b299-481b-ba1a-91dc1bbdaa72”,
“tags”: [ ],
“templateId”: null,
“types”: [“Zone”],
“updatedAt”: “2021-05-03T11:49:57.859+05:30”,
“updatedBy”: “00000000-0000-0000-0000-000000000000”
}]
},
{
“entityType”: “Element”,
“values”: [
{
“createdAt”: “2021-05-03T11:49:50.080+05:30”,
“createdBy”: “00000000-0000-0000-0000-000000000000”,
“customAttributes”: {“gatewayType”: “{\“value\”:\“Niagara\”}”},
“hasCloudPlatformBinding”: {
“ExternalId”: “4f9b3336-3dd0-4c02-b6b0-069f10a40775”,
“GatewayId”: “a6b7797c-7b9a-41d5-819d-678f6f3e4e9b”,
“SystemGuid”: “75e70ebf-0fb8-4036-9c89-a6bb2e5e1db6”
},
“hasSchedules”: [ ],
“id”: “4f9b3336-3dd0-4c02-b6b0-069f10a40775”,
“name”: “OT1_FIRST_FLOOR”,
“siteId”: “57ba1fbc-b299-481b-ba1a-91dc1bbdaa72”,
“types”: [
“Device”,
“Generic”
],
“updatedAt”: “2021-05-03T11:49:50.081+05:30”,
“updatedBy”: “00000000-0000-0000-0000-000000000000”
},
{
“createdAt”: “2021-05-03T11:49:49.397+05:30”,
“createdBy”: “00000000-0000-0000-0000-000000000000”,
“customAttributes”: {“gatewayType”: “{\“value\”:\“Niagara\”}”},
“hasCloudPlatformBinding”: {
“ExternalId”: “a6b7797c-7b9a-41d5-819d-678f6f3e4e9b”,
“GatewayId”: “a6b7797c-7b9a-41d5-819d-678f6f3e4e9b”,
“SystemGuid”: “75e70ebf-0fb8-4036-9c89-a6bb2e5e1db6”
},
“id”: “a6b7797c-7b9a-41d5-819d-678f6f3e4e9b”,
“name”: “MobileSupDemo1”,
“siteId”: “57ba1fbc-b299-481b-ba1a-91dc1bbdaa72”,
“types”: [
“Device”,
“Gateway”
],
“updatedAt”: “2021-05-03T11:49:49.398+05:30”,
“updatedBy”: “00000000-0000-0000-0000-000000000000”
}
]
},
{
“entityType”: “Property”,
“values”: [
{
“createdAt”: “2021-05-03T11:49:50.878+05:30”,
“createdBy”: “00000000-0000-0000-0000-000000000000”,
“customAttributes”: {
“categories”:
“historyLocation”:
“{\“value\”:\“history$3a$2f$2fmobilesupdemo1$2fot1_{—}first_{—}floor_{—}fcul$242e5$2420setp
oint\”}”,
“isWritable”: “{\“value\”:\“true1”}”,
“max Value”: “{\“value\”:\“25.00\”}”,
“minValue”: “{\“value\”:\“15.00\”}”,
“precision”: “{\“value\”:\“\”}”,
“stepSize”: “{\“value\”:\“1\”}”
},
“dataSourceType”: “Measured”,
“dataType”: “Numeric”,
“entityId”: “4f9b3336-3dd0-4c02-b6b0-069f10a40775”,
“entityType”: “Element”,
“enumOptions”: { },
“hasCloudPlatformBinding”: {
“ExternalId”: “MobileSupDemo1!1c78”,
“GatewayId”: “a6b7797c-7b9a-41d5-819d-678f6f3e4e9b”,
“SystemGuid”: “75e70ebf-0fb8-4036-9c89-a6bb2e5e1db6”
},
“id”: “4cdab4d1-b9f4-4c5a-8acd-2efb8f9bb2a8”,
“name”: “FCU1.5 Setpoint”,
“propertyrolename”: “EffectiveSetpoint”,
“types”: [“HardwarePoint”],
“unit”: “celsius”,
“updatedAt”: “2021-05-03T11:49:50.879+05:30”,
“updatedBy”: “00000000-0000-0000-0000-000000000000”
},
{
“createdAt”: “2021-05-03T11:49:51.016+05:30”,
“createdBy”: “00000000-0000-0000-0000-000000000000”,
“customAttributes”: {
“categories”:
“historyLocation”:
“{\“value\”:\“history$3a$2f$2fmobilesupdemo1$2ffcu1$242e5$2420occupancy$2420sen
sor\”}”,
“isWritable”: “{\“value\”:\“false\”}”,
“max Value”: “{\“value\”:\“\”}”,
“minValue”: “{\“value\”:\“\”}”,
“precision”: “{\“value\”:\“\”}”,
“stepSize”: “{\“value\”:\“1\”}”,
“summarySupports”: “{\“value\”:\“false\”}”
},
“dataSourceType”: “Measured”,
“dataType”: “Boolean”,
“entityId”: “4f9b3336-3dd0-4c02-b6b0-069f10a40775”,
“entityType”: “Element”,
“enumOptions”: {
“options”: [
{
“text”: “FALSE”,
“value”: “false”
},
{
“text”: “TRUE”,
“value”: “true”
}
],
“resourceId”: “”
},
“hasCloudPlatformBinding”: {
“ExternalId”: “MobileSupDemo1!1c82”,
“GatewayId”: “a6b7797c-7b9a-41d5-819d-678f6f3e4e9b”,
“SystemGuid”: “75e70ebf-0fb8-4036-9c89-a6bb2e5e1db6”
},
“id”: “924da9d5-3fd3-4bdc-afd4-9247762d38c9”,
“name”: “FCU1.5 Occupancy Sensor”,
“propertyrolename”: “EffectiveOccupancy”,
“types”: [“HardwarePoint”],
“unit”: “”
“updatedAt”: “2021-05-03T11:49:51.016+05:30”,
“updatedBy”: “00000000-0000-0000-0000-000000000000”
},
“createdAt”: “2021-05-03T11:49:50.562+05:30”,
“createdBy”: “00000000-0000-0000-0000-000000000000”,
“customAttributes”: {
“categories”:
“historyLocation”:
“{\“value\”:\“history$3a$2f$2fmobilesupdemo1$2ffcu1$242e3$2420room$2420tempera
ture\”}”,
“isWritable”: “{\“value\”:\“false\”}”,
“maxValue”: “{\“value\”:\“\”}”,
“minValue”: “{\“value\”:\“\”}”,
“precision”: “{\“value\”:\“\”}”,
“stepSize”: “{\“value\”:\“1\”}”
},
“dataSourceType”: “Measured”,
“dataType”: “Numeric”,
“entityId”: “4f9b3336-3dd0-4c02-b6b0-069f10a40775”,
“entityType”: “Element”,
“enumOptions”: { },
“hasCloudPlatformBinding”: {
“ExternalId”: “MobileSupDemo1!1c60”,
“GatewayId”: “a6b7797c-7b9a-41d5-819d-678f6f3e4e9b”,
“SystemGuid”: “75e70ebf-0fb8-4036-9c89-a6bb2e5e1db6”
},
“id”: “19b5ac25-3084-4ec1-a525-c38b9028656e”,
“name”: “FCU1.3 Room Temperature”,
“propertyrolename”: “ZoneTemperature”,
“types”: [“HardwarePoint”],
“unit”: “celsius”,
“updatedAt”: “2021-05-03T11:49:50.562+05:30”,
“updatedBy”: “00000000-0000-0000-0000-000000000000”
}
]
},
],
}

Generation of a building ontology model may be noted. The building ontology model may be used in most of a building is as shown. The ontology model may be built based on the building data in a model store.

Organization hierarchy may be looked at. a data model and each sub system including equipment information may be generated and stored in a data base. The overview of model schema may be stored in a model store. Automated equipment modeling may be looked at.

As to workflow, following is applicable.
1. User may add new equipment and add/updates points into newly added equipment.
2. Once user adds new equipment and saves, a model sync service API may call to send a system command with newly updated data.
3. The system command may be passed via device communication and MW device communication services.
4. Once the system command reaches a gateway, the gateway may acknowledge and respond with a status accepted.
5. Once a response reaches model service, a model may be updated. At the gateway side,
   a. Gateway may partially update the model.
   b. After receiving a 1st system command, the gateway may wait for a predefined time.
   c. While waiting, if gateway receives another command, the wait period will be restarted.
   d. Once waiting period is elapsed, a model sync may be initiated.

Point tagging in a supervisor may be noted.

How to make and use the present system may be noted. The system may be used across BMS projects such as a remote building manager, SaMBa supervisor, common supervisor, and so on.

The following may be features of the present system.
1. Automated tagging of points and equipment in a cloud.
2. Getting of context automatically from related entities such as a point and device name, description, and so on.
3. Easily enhance the asset model by applying templates for a site which does not have a naming convention.
4. Automatic adjustments of entities and relationship in gateway when asset model changes are done in a cloud.
5. Intuitive and easy process for adjusting the asset modelling from the cloud.
6. Reduction in onboarding time for a site.

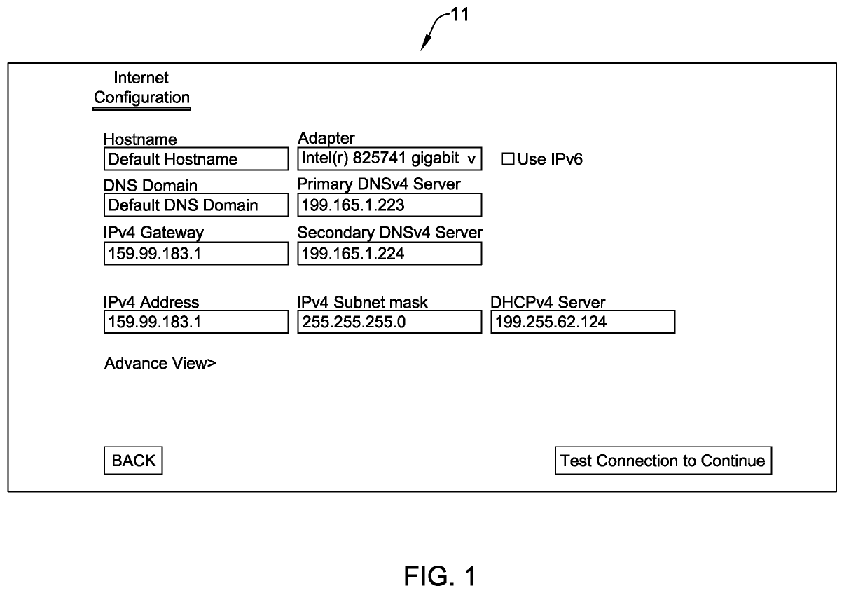

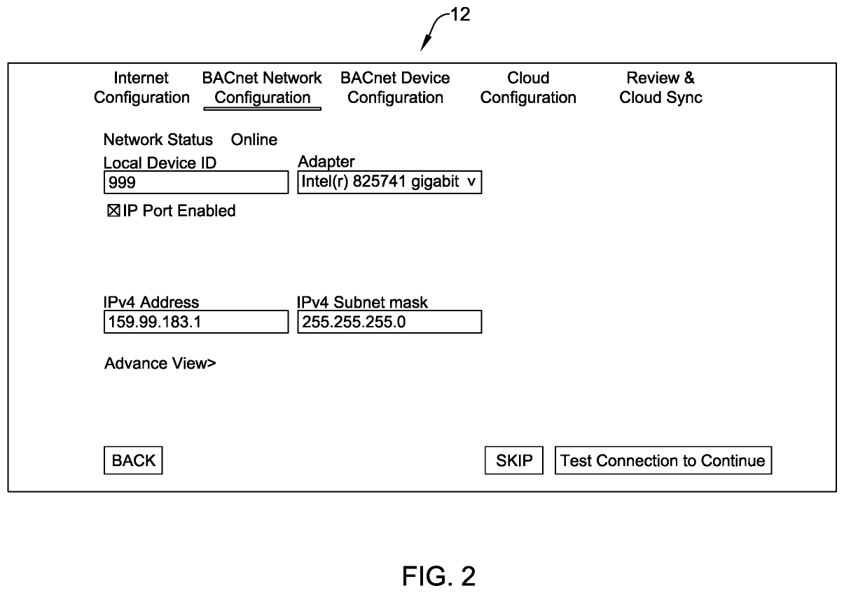

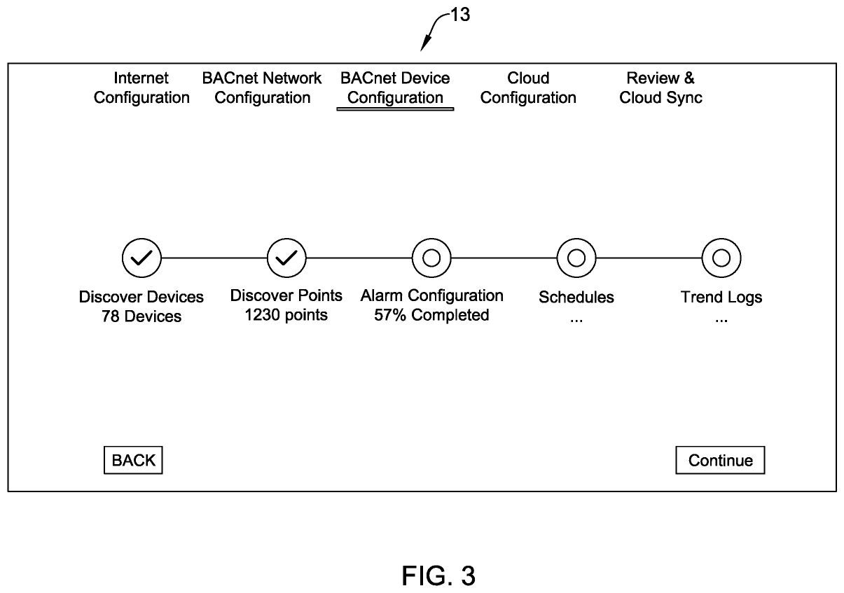

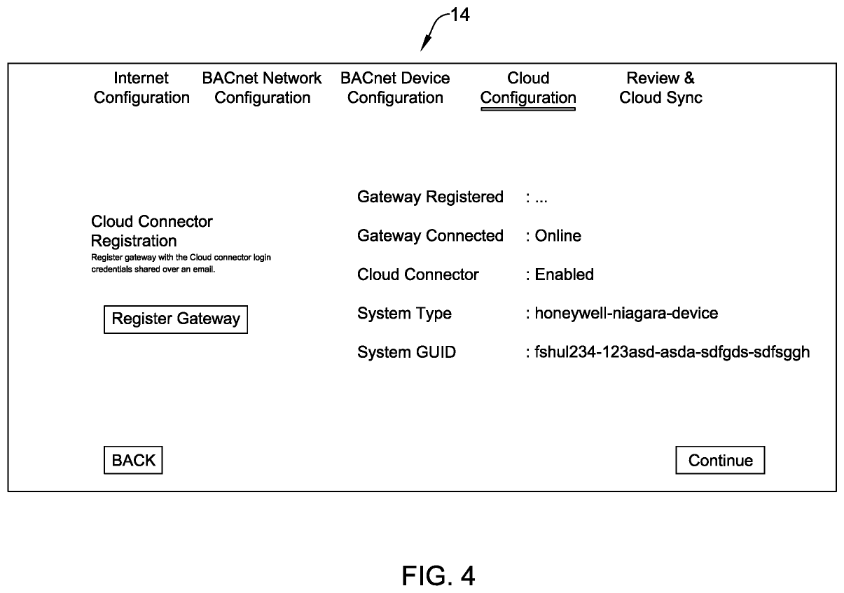

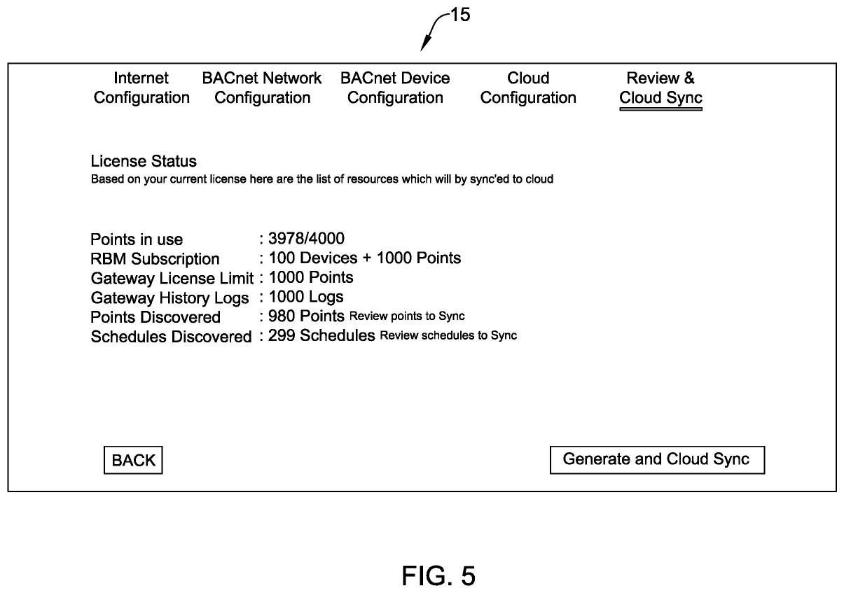

A set of FIGS. 1-5 shows an approach for onboarding a remote building manager (RBM) gateway onboarding setup. FIG. 1 is a diagram 11 revealing an internet configuration. FIG. 2 is a diagram 12 revealing a BACnet network configuration. FIG. 3 is a diagram 13 revealing a BACnet device configuration. FIG. 4 is a diagram 14 revealing a cloud configuration. FIG. 5 is a diagram 15 revealing a review and cloud sync.

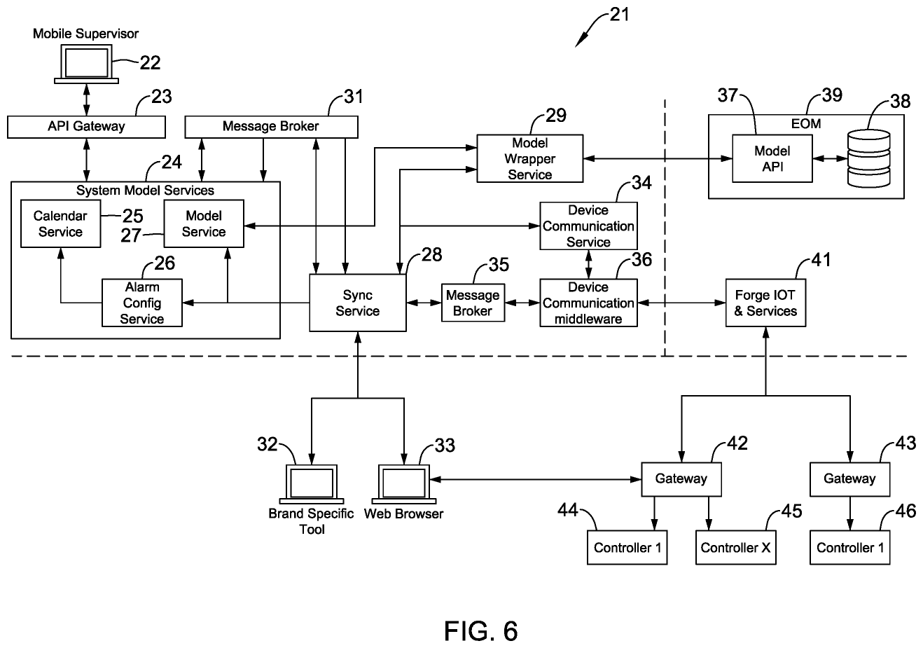

FIG. 6 is a diagram 21 of an onboarding architecture. A two way connection may connect mobile supervisor 22 to an API gateway 23. There may be an API connection between a system model services 24 and API gateway 23.

Within services 24 may be a connection between calendar service 25 and an alarm configuration service 26. A connection may be from service 26 to sync service 28. A model service 27 may be connected to a model wrapper service 29. Within services 24, there should be an update of the needed entities sent as a part of a sync model. A message broker 31 may have a crud events connection with services 24, a site lock event connection to services 24, a site lock event connection from sync service 28 and a crud events connection to sync service 28. A brand specific tool 32 and a web browser 33 may be connected with sync service 28.

A read file connection may be between device communication service 34 and sync service 28 and model wrapper service 29. A file upload event connection is between message broker 35 and sync service 28. A connection may exist between device communication middleware 36 and message broker 35. Device communication middleware 36 may be connected with device communication service 34.

Model wrapper service 29 may have a model sync connection with model API 37 in EOM 39. A storage device 38 may be connected with model API 37 in EOM 39.

Middleware 36 may be a connection with IoT and services 41, for file upload event/system commands. A file upload/configuration update command connection may be between services 41 and gateway 42 and gateway 43. A connection may be between gateway 42 and web browser 33. Gateway 42 may have connections to controllers 44 and 45. Gateway 43 may have a connection to controller 46.

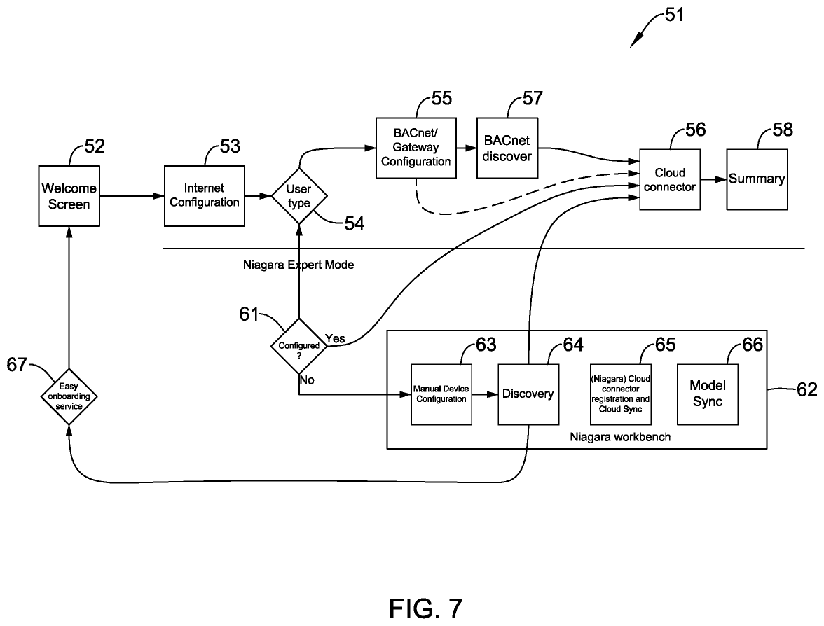

FIG. 7 is a diagram 51 of a gateway onboarding user navigation. Block 52 may be a welcome screen with an output with a server option of US or EU to an internet configuration 53 having an output to a decision symbol 54 where a user type is selected from choices BACnet wizard and a Niagara Expert Mode.

One may go first with a BACnet wizard option. Shown by block 53 revealing a BACnet gateway configuration using a BACnet protocol. If BACnet is shipped, these may be a dialogue box about the consequences of such decision which follows a dashed line to a block 56 representing a cloud connector. Going with BACnet at block 53 results in going to block 57 for BACnet discovery. A feature is the auto discovery. An output from a discovery block 57 may go cloud connector block 56. Features at block 56 may be a license summary and easy cloud registration. Block 58 is a summary indicating model based auto tagging, point sync-up with a cloud, and schedule management.

An alternate decision at symbol 54 may be a Niagara Expert Mode which may have a protocol of BACnet, Modbus or Fox. One may go into a dialogue box on a Niagara workbench. At decision symbol 61, a question may be whether the mode is configured or not. If an answer is yes at symbol 61, then cloud connector 56 with the above-noted features may be incurred. Following that, the summary 58 may occur with its above noted features.

If an answer at decision symbol 61 is no configuration, then a Niagara workbench in symbol 62 may apply starting with a manual device configuration at symbol 63. From symbol 63, discovery of symbol 64 may take place with a signal back to the wizard of cloud connection 56. An output from discovery at symbol 64 may go to a decision at symbol 67 for easy onboarding service to block 52 of the welcome screen.

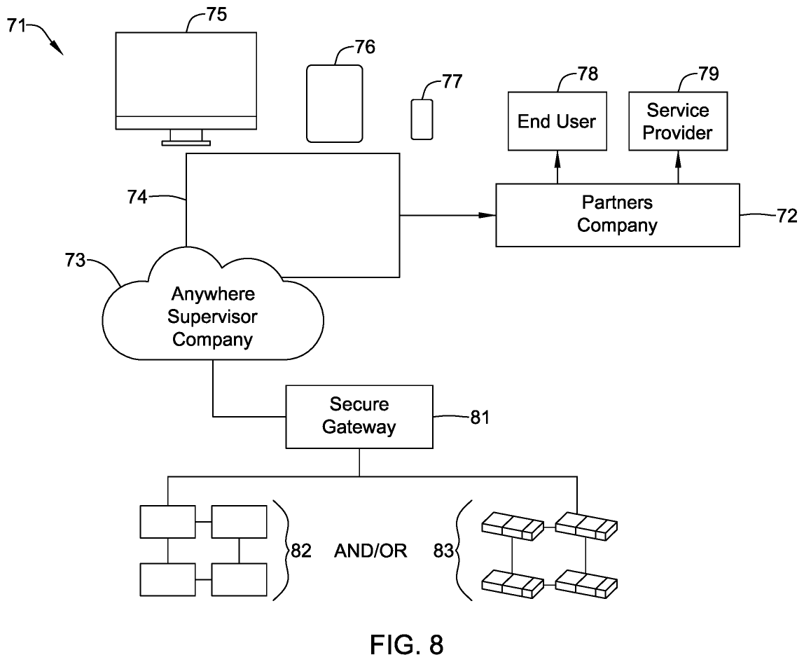

FIG. 8 is a diagram 71 of a basic layout of a system for the present onboarding. Company partner or partners 72 may have an input from a company anywhere supervisor 73 which may be represented by a computer monitor 74, screen 75, pad 76 and/or phone 77. Company partner or partner 72 may provide output information to an end user 78 and service provider 79. Supervisor 73 may be connected to a secure gateway 81 which, in turn, may be connected to devices 82 and/or other items 83.

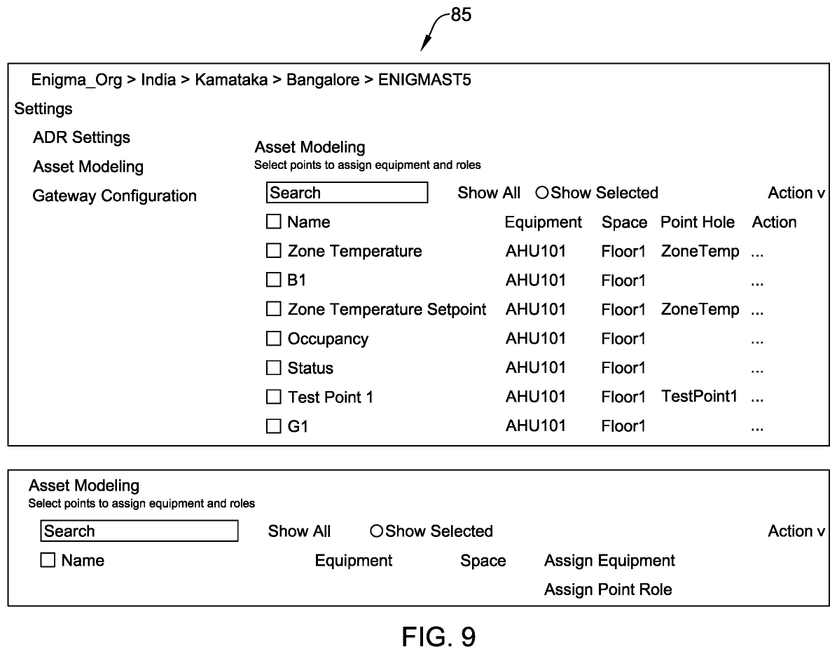

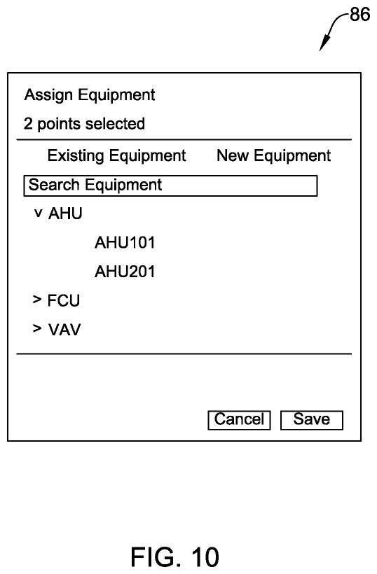

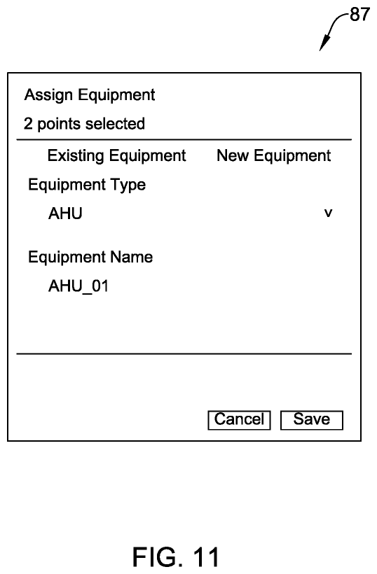

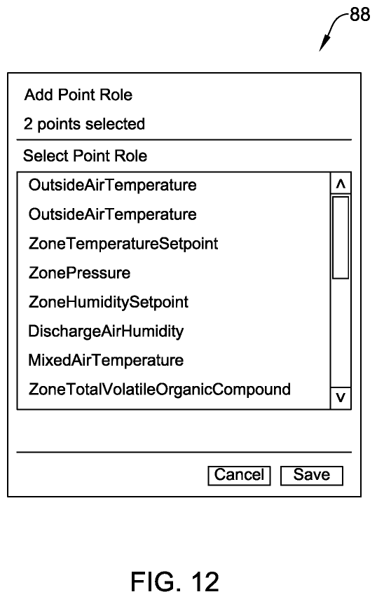

FIG. 9 is a diagram 85 of an example screen or dashboard showing selections for asset modeling (if selected) or for ADR settings or a gateway configuration. FIG. 10 is a diagram 86 of an example of assigned existing equipment. FIG. 11 is a diagram 87 of an example of assigned new equipment. The equipment may be found through a search function and results of the searches may be saved or cancelled in diagrams 86 and 87. FIG. 12 is a diagram 88 for an add point role. A selection of a point role may be made from a list of temperature, humidity, pressure and a zone total volatile organic compound.

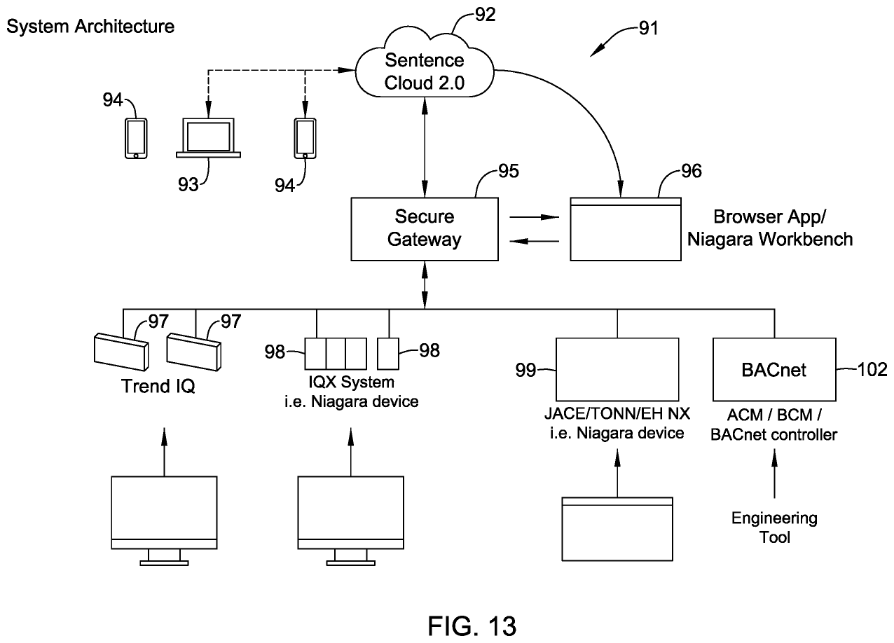

FIG. 13 is a diagram 91 of an example architecture of the present system and approach. A sentinence cloud 92 may have a dotted line connection to a monitor 93 and phones 94. Sentinence cloud 92 may be connected to a secure gateway 95. Cloud 92 may also be connected to a browser/Niagara workbench 96. Workbench 96 may be connected to gateway 95. Secure gateway 95 may be connected to trend IQ items 97, IQX system (i.e., Niagara device) 98, JACE/TONN/EH NX (i.e., Niagara device) 99, and ACM/BCM BACnet controller 102.

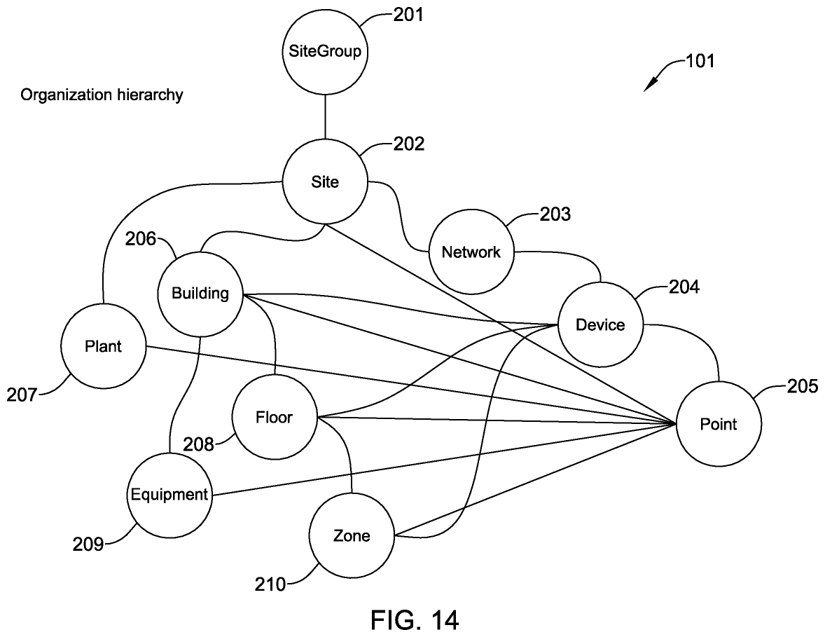

FIG. 14 is a diagram 101 of a generation of a building ontology model. The model may be used in much of a building. It may be built based on building data in a model store. A group 201 may be connected to a site 202. Site 202 may be connected to network 203, which in turn is connected to device 204. Device 204 may be connected to a point 205. Site 202 may be connected to building 206 and plant 207. Building 206 may be connected to a floor 208 and equipment 209. Building 206 may be connected to device 204. Floor 208 may be connected to device 204 and zone 210, which in turn is connected to device 204. Point 205 may have a connection with site 202, building 206, plant 207, floor 208, equipment 209 and zone 210.

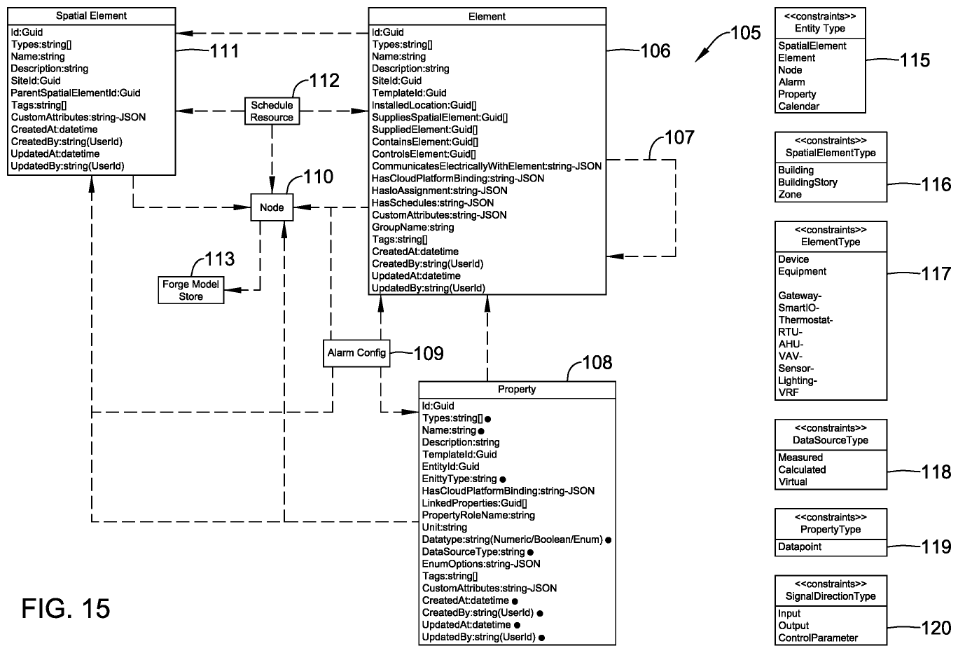

FIG. 15 is a diagram 105 showing a generation of a building ontology model. Block 106 may list elements and associated information. A path 107 may list various kinds of elements in block 106. Properties may be listed in block 108. A connection may go from property block 108 to an element block 106. An alarm configuration block 109 may be connected to property block 108 and be connected to element block 106. Alarm configuration block 109 may also be connected to a node block 110. A connection may go from element block 106 to node block 110.

A spatial element block 111 may be connected to node block 110. A connection may be made from element block 106 to spatial element block 111. A schedule resource block 112 may be connected to mode block 110, element block 106 and spatial element block 111. A connection from node 110 may be made to model store block 113. Model store 113 may store the model ID and create a gateway under the same to set the storage retention policies. A connection may proceed from property 108 to mode block 110 and to spatial element block 111. Mandatory properties in property block 108 are indicated in bold type and/or a dot at the end of the label.

Blocks to the right of diagram 105 may indicate various constants. Block 115 may list entity type of spatial element, element, node, alarm, property, and calendar. Block 116 may list spatial element types of building, building store and zone. Block 117 may list element types of device, equipment, gateway, smart IQ, thermostat, RTU, AHU, VAV, sensor, lighting and VRF. Block 118 may list data source types of measured, calculated and virtual. Block 119 may list a property type of a data point. Block 120 may list a signal direction type of input, output and control parameter.

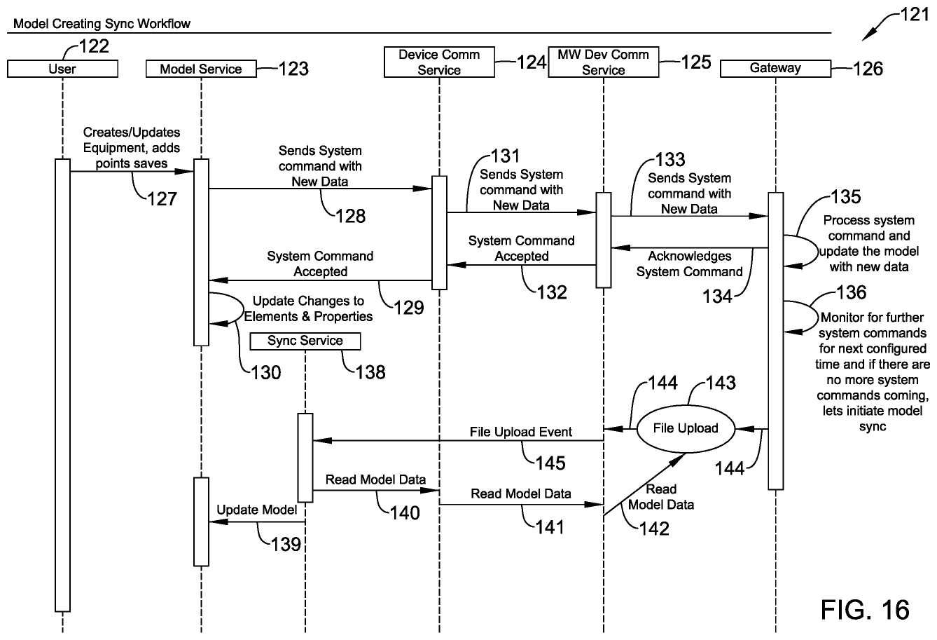

FIG. 16 is a diagram 121 of a model creating sync workflow chart. A user 122 may at line 127 create/update equipment, add points and save from user 122 to model service 123. Model service 123 may send a system command with new data at line 128 from model service 123 to device comm service 124. The system command may be accepted with line 129 from device comm service 124 to model service 123. Line 130 may indicate changes to elements and properties at model service 123. A line 131 from device comm service 124 to MV day comm service 125 may send a system command with new data. A line 132 from MV day comm service 125 to device comm service 124 may indicate the system command accepted. A line 133 from MW day common service 125 to gateway 126 may send a system command with new data. Line 134 may acknowledge the system command from gateway 126 to MW day comm service 125.

As a line 135 from gateway 126 to itself, there may be a process system command and update of the model with new data. As a line 136 from gateway 126 to itself, there may be a monitor for further system commands for the next configured time, and if there are no more system commands coming, then a model sync may be initiated.

A sync service 138 may be noted. A line 139 up-dating a model may go from sync service 138 to model service 123. A line 140 may indicate to read model data, from sync service 138 to device comm service 124. A line 141 from device comm service 124 to MV day comm service 125, may indicate to read model data. A line 142 from MW day comm service 125 to symbol 143, may indicate read model data. A line 144 that runs from gateway 126 through symbol 143 may indicate a file upload, and go on to MW day comm service 125. A line 145 from MW day comm service 125 to sync service 138 may indicate to file the upload event.

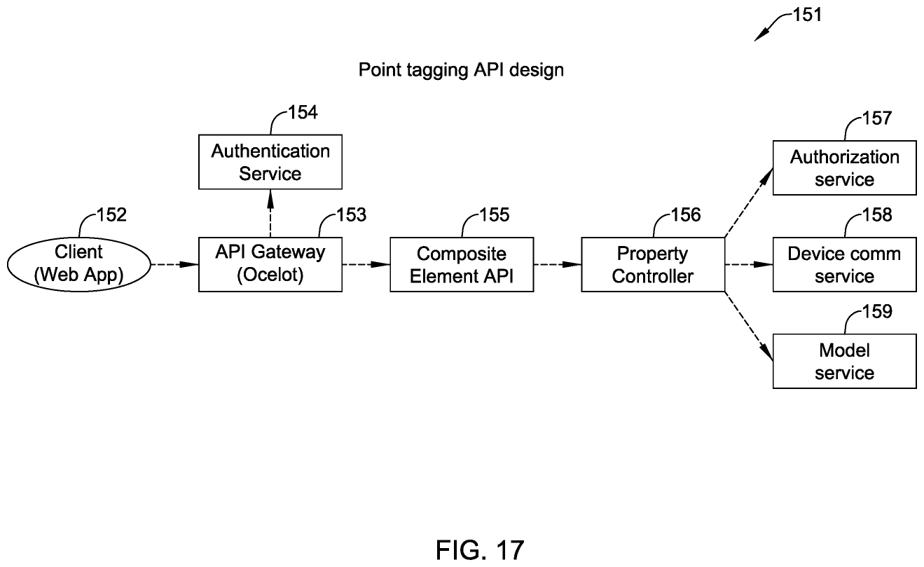

FIG. 17 is a diagram 151 showing a point tagging API design. A client web app list at symbol 152 may have an output to an API gateway (Ocelot) 153. An output from gateway 153 may go to a symbol 154 representing an authentication service. Another output from API gateway at symbol 153 may go to a composite element API at symbol 155. An output from element at symbol 155 may go to a property controller at symbol 156. Three outputs may be from property controller 156. The three outputs may be an authorization service at symbol 157, a device comm service at symbol 158, and model service at symbol 159.

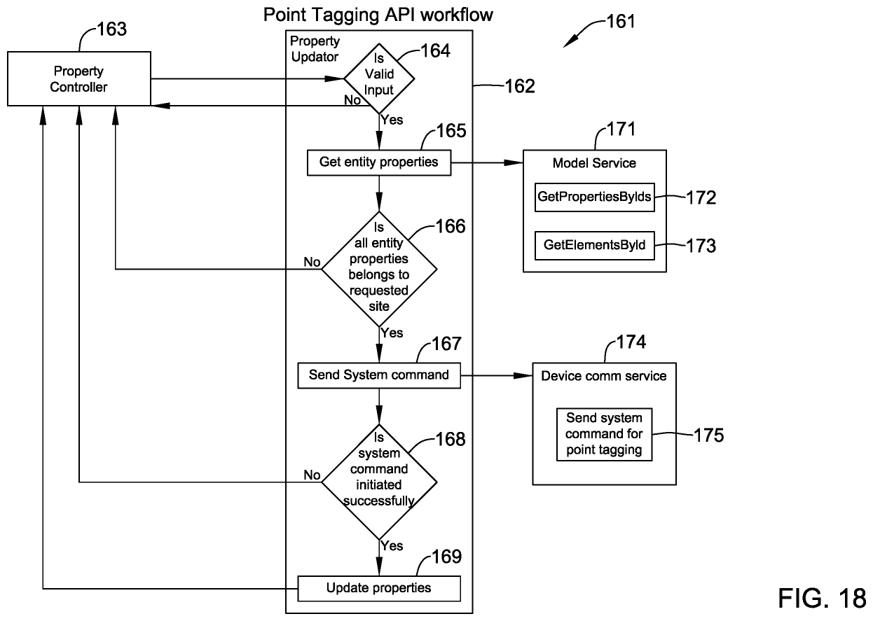

FIG. 18 is a diagram 161 representing a point tagging API workflow. A property controller at symbol 163 may have an output to a decision symbol 164 within property updator or updater 162. Decision symbol 164 may determine whether the input to it is valid or not. If an answer is No, then that response is sent to the property controller of symbol 163. If the answer is Yes, then a signal goes from symbol 164 to a symbol 165 that indicates to get entity properties. One output from symbol 165 may go to a model service symbol 171 which contains a symbol 172 that notes to get properties bylds and a symbol 173 that notes to get elements byld. Another output from symbol 165 may go to a decision symbol 166 that asks whether all entity properties belong to a requested site. If an answer is No, then that response may be sent to property controller at symbol 163. If the answer is Yes, then that response may go to a symbol 167 that indicates to send a system command. One output from symbol 167 may go to a device comm service at symbol 174. A symbol 175 within symbol 174 may indicate to send a system command for point tagging. Another output from symbol 167 may be a Yes to send a system command to a decision symbol 168 asking whether a system command was initiated successfully. If an answer is No, then such signal indication may be sent to a property controller at symbol 163. Another output from symbol 168 may be a yes, in that the system command was initiated successfully, and sent to a symbol 169 that indicated to update properties. An output of symbol 169 in property update symbol 162, may be a signal to property controller 163 to return a status code.

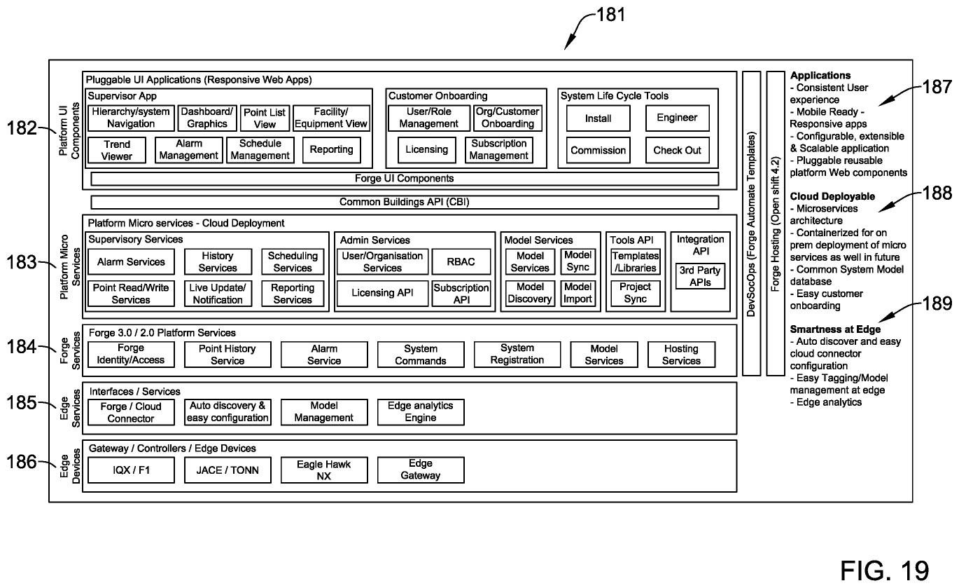

FIG. 19 is a diagram 181 of a rbm system architecture. Horizontal portions of the architecture 181 may incorporate rows of platform user interface components 182, platform micro services 183, Forge™ services 184, edge services 185, and edge devices 186. To the right of diagram 181, items may include applications 187, cloud deployable items 188, and smartness at edge items 189.

To recap, an approach of an onboarding wizard may incorporate a first step configured to select an area or environment for application of a wizard, a second step configured for the wizard to automatically verify internet connectivity of a network, a third step configured to continue with the wizard to narrow the network within a protocol selected from a group comprising a BACnet protocol, a Niagara expert mode, Workbench view for Modbus, and Fox Protocol, a fourth step configured for the wizard to register a cloud connector to a cloud IoT for pushing data, and a fifth step configured to permit a user review tags automatically applied, and to adjust them as needed.

As an area or environment of application of the wizard may be to select a US or EU area or environment subject to a General Data Protection Regulation (GDPR) or select an area or environment not subject to the GDPR.

Upon verifying internet connectivity at the second step, a user may be prompted to continue with the wizard of the BACnet protocol, a Niagara expert mode, Workbench view for Modbus, or Fox Protocol.

Once configured after the third step, the specific network may automatically scan the network for devices, points, history, alarms, and schedules. Automatically, each scanned item may get added based on metadata information exposed over the specific network driver, which helps in setting configurations without a need for manual intervention thereby reducing the onboarding time. A user may review the items discovered by an automated process and remove any unneeded items. Once an item is removed, a subsequent review will not necessarily include the removed item.

The approach may further incorporate applying tagging for points and equipment automatically based on a tag dictionary. By default, the tag dictionary may have tags and equipment available for HVAC applications. If a user needs a customization, the user may do the customization once and take the change or changes of the customization for another job.

If the steps occur satisfactorily, then the wizard may go ahead and perform a sync of an asset model generated in the gateway to the cloud. The present approach may be used across building management system (BMS) projects of one or more items of a group comprising a remote building manager, small and medium building administrator (SaMBa), supervisor, and common supervisor.

A wizard based gateway onboarding to a cloud, may incorporate an environment of a designated social political area, and a network configured to automatically verify internet connectivity, and configured to automatically scan the network for items incorporating devices, points, history, plans and schedules. The items that are scanned may get added based on metadata information exposed over the network driver.

An item getting added may avoid a need for manual intervention.

The wizard based gateway onboarding to a cloud may further incorporate a cloud connection registered by the wizard to a cloud IoT for pushing data points and equipment tagged by the wizard based on a tag dictionary.

Automatically based on the tag dictionary, tags and equipment may be available for points and HVAC applications.

The wizard based gateway onboarding to a cloud may further incorporate reviewing tags automatically applied, and adjusting them as needed.

The wizard may perform a sync of an asset model generated in the gateway to the cloud.

A building management system (BMS) onboarding gateway process may incorporate gateway onboarding, and tagging used in a cloud supervisor for getting context about an asset model. During onboarding based on points and devices, points and equipment may get tagged. Based on tags, an asset model may be created in a gateway. The asset model may get pushed to a cloud supervisor. The asset model and tags in the supervisor may be reviewed. The tags may be adjusted in the gateway and resynced. A gateway's automatically adjusting entities for asset modeling performed in the cloud, may cause onboarding time to load a gateway to decrease by at least a magnitude.

Automated tagging based on context of point names, description names, device names, and description may be available in the gateway.

There may be automated tagging of points and equipment in the cloud.

Context may be obtained automatically from related entities selected from a group comprising point and device names, and descriptions. The asset model may be enhanced by applying templates for a site without a naming convention.

Automatic adjustments of entities and relationships in the gateway may occur when changes of the asset model are done in a cloud.

A minimum tagging and creation of the asset model in the gateway may be part of gateway onboarding. The asset model may be published to a cloud supervisor and get stored in the model store. When the asset model is available in the cloud, an asset modeling feature may allow a user with privileges to enhance the asset model by adding extra content about points and equipment based on name and description of points, and devices.

Asset modeling may automatically suggest enhancement to tagging and an asset model based on available context. Users may accordingly adjust review. Once reviewed, changes may be published back to the asset model. Changes may be reviewed immediately to assure virtually everything is correct. Any changes needed to be applied in the gateway may be sent as a system command to the gateway.

A gateway's automatically adjusting entities for asset modeling performed in the cloud, may cause onboarding time to load a gateway to decrease at least ten times, ninety percent, or other amount.

Any publication or patent document noted is hereby incorporated by reference to the same extent as if each publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. An approach of an onboarding wizard comprises:
a first step configured to select an area or environment for application of a wizard;
a second step configured for the wizard to automatically verify internet connectivity of a network;
a third step configured to continue with the wizard to narrow the network within a protocol selected from a group comprising a BACnet protocol, a Niagara expert mode, Workbench view for Modbus, and Fox Protocol;
a fourth step configured for the wizard to register a cloud connector to a cloud IoT for pushing data; and
a fifth step configured to permit a user review tags automatically applied and to adjust them as needed.

2. The approach of claim 1, wherein an area or environment of application of the wizard is to select a US or EU area or environment subject to a general data protection regulation (GDPR) or select an area or environment not necessarily subject to the GDPR.

3. The approach of claim 1, wherein upon verifying internet connectivity at the second step, a user is prompted to continue with the wizard of the BACnet protocol, a Niagara expert mode, Workbench view for Modbus, or Fox Protocol.

4. The approach of claim 1, wherein:
once configured after the third step, the specific network automatically scans the network for devices, points, history, alarms, and schedules;
automatically, each scanned item gets added based on metadata information exposed over the specific network driver, which helps in setting configurations without a need for manual intervention thereby reducing the onboarding time;
a user can review the items discovered by an automated process and remove any unneeded items; and
once an item is removed, a subsequent review will not necessarily include the removed item.

5. The approach of claim 1, further comprising:
applying tagging for points and equipment automatically based on a tag dictionary; and
wherein:
by default, the tag dictionary can have tags and equipment available for heating, ventilation and air conditioning (HVAC) applications; and
if a user needs a customization, the user may do the customization once and take the change or changes of the customization for another job.

6. The approach of claim 1, wherein:
if the steps occur satisfactorily, then the wizard goes ahead and performs a sync of an asset model generated in the gateway to the cloud; and
the present approach may be used across building management system (BMS) projects of one or more items of a group comprising a remote building manager, small and medium building administrator (SaMBa), supervisor, and common supervisor.

7. A wizard based gateway onboarding to a cloud, comprising:
an environment of a designated social political area; and
a network configured to automatically verify internet connectivity, and configured to automatically scan the network for items incorporating devices, points, history, plans and schedules; and
wherein the items that are scanned get added based on metadata information exposed over the network driver.

8. The onboarding of claim 7, wherein an item getting added avoids a need for manual intervention.

9. The onboarding of claim 7, further comprising a cloud connection registered by the wizard to a cloud IoT for pushing data points and equipment tagged by the wizard based on a tag dictionary.

10. The onboarding of claim 9, wherein automatically based on the tag dictionary, tags and equipment are available for points and HVAC applications.

11. The onboarding of claim 7, further comprising reviewing tags automatically applied, and adjusting them as needed.

12. The onboarding of claim 11, wherein the wizard performs a sync of an asset model generated in the gateway to the cloud.

13. A building management system (BMS) onboarding gateway process comprises:
gateway onboarding; and
tagging used in a cloud supervisor for getting context about an asset model; and
wherein:
during onboarding based on points and devices, points and equipment get tagged;
based on tags, an asset model is created in a gateway;
the asset model gets pushed to a cloud supervisor;
the asset model and tags in the supervisor are reviewed;
the tags are adjusted in the gateway and resynced; and
a gateway's automatically adjusting entities for asset modeling performed in the cloud, causes onboarding time to load a gateway to decrease by at least a magnitude.

14. The process of claim 13, wherein automated tagging based on context of point names, description names, device names, and description are available in the gateway.

15. The process of claim 14, wherein there is automated tagging of points and equipment in the cloud.

16. The process of claim 15, wherein:
context is obtained automatically from related entities selected from a group comprising point and device names, and description; and
the asset model is enhanced by applying templates for a site without a naming convention.

17. The process of claim 16, wherein automatic adjustments of entities and relationships of the gateway occur when changes of the asset model are done at a cloud.

18. The process of claim 17, wherein:
a minimum tagging and creation of the asset model in the gateway are part of gateway onboarding;
the asset model is published to a cloud supervisor and gets stored in the model store; and
when the asset model is available in the cloud, an asset modeling feature allows a user with privileges to enhance the asset model by adding extra content about points and equipment based on name and description of points, and devices.

19. The process of claim 18, wherein:
asset modeling automatically suggests enhancement to tagging and an asset model based on available context;
users can accordingly adjust review the asset model and tags;
once reviewed, changes can be published back to the asset model;
changes can be reviewed immediately to assure everything is correct; and
any changes needed to be applied in the gateway are sent as a system command to the gateway.

20. The process of claim 19, wherein a gateway's automatically adjusting entities for asset modeling performed in the cloud, causes onboarding time to load a gateway to decrease.
